(19) United States
(12) Patent Application Publication
(10) Pub. No.: US 2016/0154909 A1
(43) Pub. Date: Jun. 2, 2016

(54) AIRFRAME-ENGINE AERODYNAMIC SIMULATION USING A MIXING PLANE SUBDIVIDED INTO ANGULAR SECTORS

(71) Applicant: Airbus Operations (S.A.S.), Toulouse (FR)

(72) Inventors: Christophe Bourdeau, Toulouse (FR); Florian Blanc, Bristol (GB); Marc Julian, Cadours (FR)

(21) Appl. No.: 14/950,246

(22) Filed: Nov. 24, 2015

(30) Foreign Application Priority Data
Nov. 24, 2014 (FR) 1461348

(51) Int. Cl. G06F 17/50

(52) U.S. Cl. CPC G06F 17/5009; G06F 17/5095

(57) ABSTRACT

The present disclosure relates to a method of simulation by computer of the airframe-engine interaction in an aircraft using angular segmentation of mixing planes. The method enables precise simulation of the airframe-engine aerodynamic interactions in shorter times thereby accelerating the development of the structure of the aircraft.

### CROSS-REFERENCE TO RELATED APPLICATION

This application claims priority to French Patent Application No. 1461348 filed Nov. 24, 2014, the entire disclosures of which are incorporated by reference herein.

### TECHNICAL FIELD

The present disclosure concerns the field of aeronautics. It concerns more particularly the development of the structure of aircraft.

### BACKGROUND

During such development, account is taken of the aerodynamic interactions between the engines of the aircraft and the airframe of the aircraft (i.e. its fuselage, notably including the wings and the tail).

It is a question of limiting the interactions between, on the one hand, the aerodynamic flow at the inlet and exit of the engines and, on the other hand, the aerodynamic flow over the airframe of the aircraft (for example during maneuvers).

However, the dimensions of the engines are constantly increasing: it is therefore more and more difficult to provide aerodynamic isolation between the engines and the airframe of aircraft. Accordingly, the aerodynamic interactions between the engines and the airframe can no longer be neglected and it is necessary to take account of them in the design of aircraft.

Recourse to simulation is therefore becoming unavoidable for predicting the engine-airframe aerodynamic interactions and possibly correcting them. Now, none of the known simulation methods using a sufficiently detailed representation of the airframe and the engine combined is compatible with the industrial imperatives regarding development time. Although it is possible to accept a simulation that takes a few hours, known simulation techniques necessitate several weeks, which is difficult to accept.

### SUMMARY

There is therefore a requirement for a method of simulation of the airframe-engine (or engine-airframe) aerodynamic interaction with a shorter simulation time. This is the context of the present disclosure.

A first aspect of the disclosure herein concerns a method of simulation by computer of the airframe-engine aerodynamic interaction in an aircraft, comprising:
definition of at least one mixing plane at the input and/or output of a modeling of at least one engine of the aircraft,
definition of a plurality of angular sectors of the mixing plan centered on the rotation axis of the engine,
execution of a mixing plane aerodynamic simulation based on the plurality of angular sectors,
obtaining at least one simulation result in at least one angular sector of the plurality, and
determination of the aerodynamic interaction between the engine and the airframe of the aircraft at least on the basis of the at least one result.

A method in accordance with the first aspect enables the optimum simulation of the airframe-engine (or engine-airframe) interaction offering a simulation time compatible with industrial aircraft development times and preserving satisfactory accuracy.

The calculations necessary for such a simulation are lightened. Moreover, the quantity of memory necessary for such a simulation is reduced.

All of the elements of the engine can be taken into account.

The use of angular sectors enables account to be taken of all types of flow variations, radial or circumferential, whilst preserving a reasonable calculation complexity.

A method in accordance with the first aspect furthermore enables account to be taken of the symmetry of the engine, which enables the simulation calculations to be further reduced.

The airframe of the aircraft is understood as comprising the fuselage, notably including the wings and the tail.

The use of a method in accordance with the first aspect is part of the industrial process of development of the structures of aircraft. It enables development time to be saved by reducing the necessary simulation times. In particular, it offers great flexibility since a plurality of simulations may be launched successively to adapt development parameters in times compatible with the timescales to be complied with in the field.

A method in accordance with the first aspect is implemented using a computer.

For example, the sectors are regular in at least one part of the mixing plane and simulation calculations are carried out in a sector of the at least one part, the calculation results being extended to the other sectors of the part on the basis of their periodicity.

In accordance with embodiments, the angular sectors are defined in correspondence with the blades of the engine.

For example, the simulation is carried out for a position of the blades of the engine, simulation calculation results obtained for the position being extended to the other positions of the blades.

In accordance with embodiments, the mixing plane is subdivided into a plurality of parts and simulation calculations are carried out for at least one sector of each of the parts, the calculation results for each sector in a part being extended to the other sectors of the part on the basis of their periodicity.

For example, the sectors are defined in correspondence with meshing lines of the model.

In accordance with embodiments, at least one angular sector (for example each angular sector) has an area equal to a multiple of the area of a blade of the engine.

For example, at least one angular sector (for example each angular sector) has an area equal to the area of a blade of the engine.

The area of a blade of the engine is understood as the area of the projection of the blade onto the mixing plane along the rotation axis of the engine.

A second aspect of the disclosure herein concerns a computer simulation device configured to implement a method in accordance with the first aspect.

For example, such a device includes a processing unit configured to implement a method in accordance with the first aspect.

A third aspect of the disclosure herein concerns a computer program and a computer program product and a storage medium for such programs and product, enabling the implementation of a method in accordance with the first aspect when the program is loaded and executed by a processor of a computer simulation device in accordance with embodiments.

The subject matters of the second and third aspects of the disclosure herein offer at least the same advantages as those offered by the subject matter of the first aspect in its various embodiments.

### BRIEF DESCRIPTION OF THE DRAWINGS

Other features and advantages of the disclosure herein will become apparent on reading the present detailed description that follows, by way of nonlimiting example, and from the appended figures, in which:

FIG. 1 shows the use of a mixing plane;

FIG. 2A is a perspective view of a meshing of an engine accompanied by an object representing the aerodynamic disturbance provoked by the airframe and a segmented mixing plane at the inlet of the engine;

FIG. 2B shows a detail of the mixing plane from FIG. 2A;

FIG. 2C is a perspective view of the meshing of the engine from FIG. 2B accompanied by the object representing the aerodynamic disturbance provoked by the airframe and a mixing plane at the exit of the engine;

FIGS. 3A-3B are flowcharts of steps executed for the design of a structure of an aircraft; and

FIG. 4 is a diagram representing a computer simulation device in accordance with embodiments.

### DETAILED DESCRIPTION

The simulation of the interaction between an aircraft airframe and one of its engines is described hereinafter. This simulation uses the numerical method (or model) known as the mixing plane interface model. Hereinafter, the airframe of the aircraft is understood as comprising the fuselage, notably including the wings and the tail.

As explained in the document by Sanders et al. “Turbulence Model Comparisons for Mixing Plane Simulations of a Multistage Low Pressure Turbine Operating at Low Reynolds Numbers” (available at the address http://www.enu.kz/repository/2009/AIAA-2009-4928.pdf), in the context of a turbine, this method enables simulation of a flow passing through domains having regions in movement relative to one another.

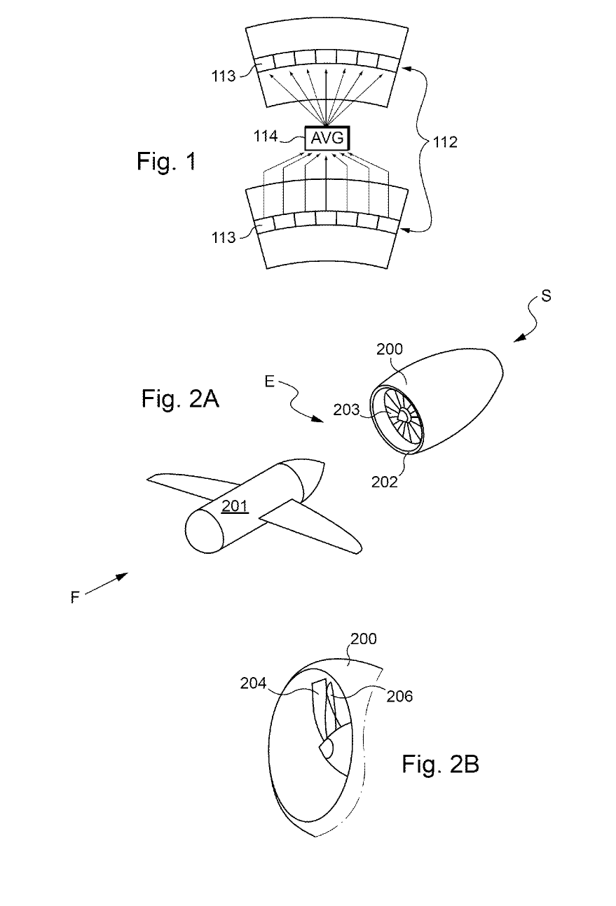

FIG. 1 shows the application of this method to an aircraft engine. The aerodynamic flow at the inlet and at the exit of the engine is averaged over lines 112 of constant radius.

Each value of the flux over a meshing element 113 of the same line is averaged 114 with the others. All the meshing elements then receive the same calculated average value.

The flow is therefore rendered constant over the lines of constant radius concerned. During the rotation of the engine, all its elements are considered to receive the same flow, regardless of their angular position during the rotation. A single simulation is therefore effected for a single position of the engine. Through considerations of symmetry, it is even possible to simulate only one blade of the engine.

In order to take account of all the variations of the flow (including the circumferential variations) and not only radial variations (therefore along a radius), advantageous modifications of the method are described hereinafter.

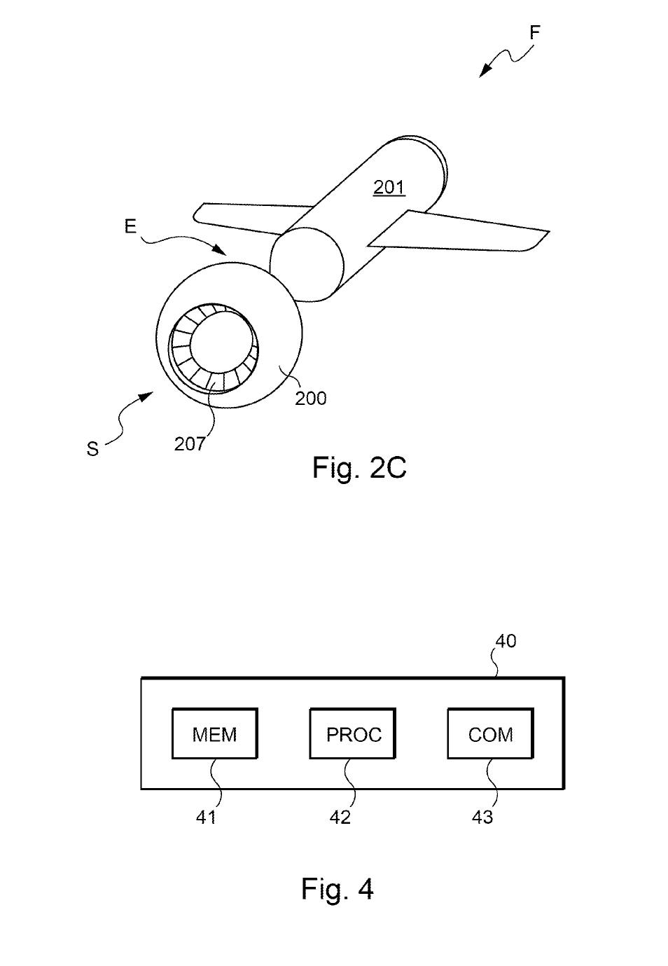

FIG. 2A includes a perspective view of the modeling 200 of an engine of an aircraft (having an inlet E and an exit S). In order to simplify the figure, only the modeling of the engine is shown. As will be apparent to the person skilled in the art, the airframe must also be modeled for the requirements of the simulation. Instead of the modeling of the airframe, FIG. 2A includes the perspective view of an object 201. The object 201 is disposed in front of the engine and disturbs an aerodynamic flow in the direction F. The object 201 therefore produces aerodynamic disturbances in front of the engine (at its inlet E) in the direction F. The object 201 therefore enables simulation of the disturbance of the aerodynamic flow at the inlet of the engine caused by the airframe of the aircraft (for example during a maneuver). In other words, the object 201 enables the airframe of the aircraft with which the engine interacts aerodynamically to be shown, in particular the area of the airframe at the level of which the engine is fixed.

Here the object 201 has a globally cylindrical shape with two fins extending radially from the cylindrical body of the object. Other shapes could be chosen, however.

The engine, as well as the object representing the airframe of the aircraft aerodynamically interacting with the engine, are meshed in accordance with a meshing the fineness of which depends on the accuracy of the results that it is required to obtain.

A mixing plane 202 between the object 201 and the engine is defined at the inlet of the engine, as close as possible to the blades.

The mixing plane is segmented into a plurality of sectors representing angular portions of the mixing plane. The sectors may be regular or irregular. It may, however, be preferable to opt for regular sectors in order to profit from properties of symmetry or of periodicity of the simulation.

The number of sectors may be determined as a function of the accuracy required for the simulation. The greater the number of sectors, the more accurate the simulation. However, the greater the number of segments, the higher the computation cost of the simulation.

A compromise can be achieved by choosing a number of sectors equal to the number of blades of the engine.

In order to lighten the simulation calculations, it may be advantageous to make the lines of the segments coincide with the lines of the meshing.

In accordance with embodiments, at least one angular sector (for example each angular sector) has an area equal to a multiple of the area of the projection of a blade of the engine onto the mixing plane along the rotation axis of the engine.

For example, at least one angular sector (for example each angular sector) has an area equal to this engine blade area.

The interface at the inlet of the engine is therefore generally subdivided into sectors respectively associated with simulation domains of components of the engine.

Using embodiments of the disclosure herein, it is possible to perform detailed aerodynamic simulations of the airframe-engine interaction using a complete representation of the engine, including the blades.

The use of a plurality of segments enables account to be taken of the distortions of flow along perpendicular and radial lines.

The use of mixing planes enables consideration of a flow that is invariant in time (the flow is the same for all the simulation times). A single time may therefore be calculated, which drastically lightens the calculations.

The calculations can be further reduced by using the periodicity of the segments of the mixing plane.

The use of angular sectors enables a more realistic simulation to be carried out of the airframe-engine interactions because within an angular sector the various distortion components can be taken into account rather than only one type of distortion as is the case with conventional mixing plane simulations. Moreover, the use of angular sectors does not render the simulation more complex because the symmetry properties may be exploited to lighten the calculations.

FIG. 2B shows in more detail a segment 204 of the mixing plane of the engine 200. This segment is disposed in front of a blade 206 of the engine. In other words, the orthogonal projection of the blade onto the mixing plane (along the axis of the engine) is contained within the sector.

Each sector may correspond to a blade, but the same sector may correspond to two or more blades.

During the simulation, the interaction between the blade 206 and the aerodynamic disturbance generated by the presence of the object 201, as shown by the segment 204, is calculated.

For the case where the segmentation is regular and associated with the blades of the engine, the remainder of the interaction is obtained by periodicity (or symmetry) by applying the results obtained for the sector 204 to the other sectors.

The periodicity may be used in various ways. For example, it is also possible to divide the mixing plane into two parts (two half-disks, four quarter-disks or more), to calculate an interaction for a sector in each part, and to extend the results obtained for each sector to other sectors of the same part.

FIG. 2C includes a perspective view of the engine 200 showing its exit S and the mixing plane at this exit of the engine. This figure also shows the object 201. In the same manner as for the inlet plane, the mixing plane may be segmented into sectors, the periodicity (or symmetry) of which may be used to economize on the simulation calculations.

In order to determine the aerodynamic flow at the inlet E or exit S of the engine, an average for the aerodynamic flow is determined in the sectors of the inlet plane and/or the exit plane. In order to economize on the calculations, this average may be calculated for a single sector for a position of the blades of the engine. The remainder of the aerodynamic flow being obtained by virtue of the periodicity of the sectors.

The known techniques for calculation of the average aerodynamic flow may be used in each plane sector.

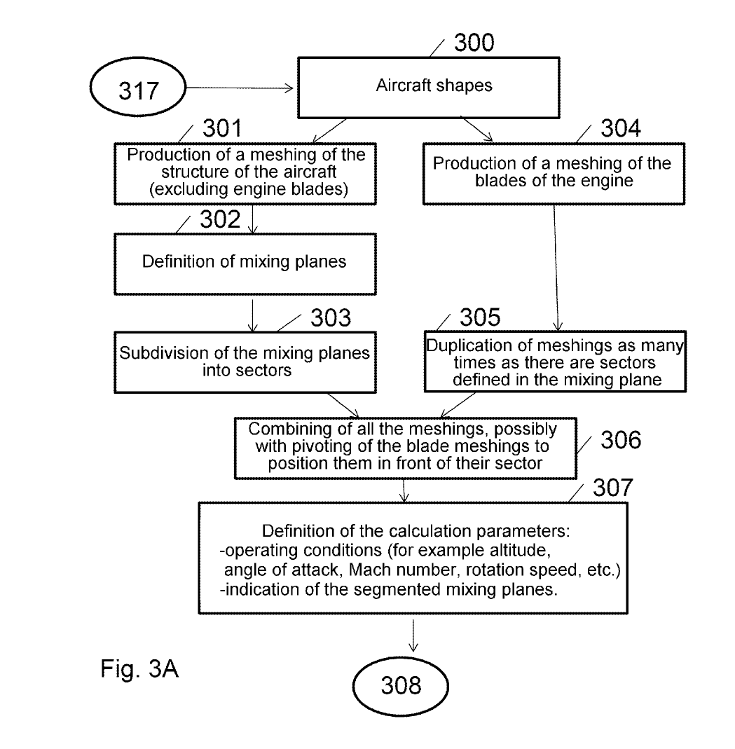

A design process including a simulation in accordance with embodiments is described hereinafter. FIGS. 3A and 3B are flowcharts of steps implemented in this design process.

In the step 300, the shapes of the airframe and the engines of the aircraft are defined. Thereafter, it is a question of determining the airframe-engine aerodynamic interaction between a given engine and the airframe the shapes of which have been defined in this step.

In a step 301, there is carried out a meshing of the aircraft with the exception of the blades of the engine. A meshing of the airframe and the engine (excluding the blades) is therefore obtained. The meshing may be carried out in accordance with techniques available to the person skilled in the art and in accordance with a degree of accuracy depending on the accuracy required for the calculations. Of course, the finer the meshing the more accurate the calculations but the longer the calculation time.

When the meshing of the airframe is obtained, the mixing planes for the aerodynamic simulation are defined. For an airframe-engine interaction between a given engine and the airframe of the aircraft, a mixing plane is defined at the inlet of the engine and a mixing plane is defined at the exit of the engine as already described hereinabove with reference to FIGS. 2A-2C.

The mixing planes are then subdivided into angular sectors. The number of angular sectors is determined as a function of the required accuracy of the calculations and the required calculation time.

In parallel, the blades of the engines, which were not modeled in the step 301, are modeled in a dedicated step 304. A meshing of the blades is therefore obtained. Using the symmetries of the engine and of the expected flow for each blade, it is possible to reduce the modeling to a single blade per component of the engine using numerical conditions of symmetry.

Each blade meshing is then duplicated in a step 305 according to the number of angular sectors defined in the step 303.

In a step 306, the meshings obtained in the steps 301 and 305 are combined to obtain a complete meshing of the aircraft. In order to refine the meshing and the aerodynamic simulation calculations that are to follow, the blade meshings may be pivoted to conform to the angular sectors of the mixing planes as defined in the step 303. As has been described hereinabove, angular sectors in front of the blades of the engine is a preferred arrangement.

When the complete meshing of the aircraft has been obtained following the step 306, the aerodynamic simulation may be launched. Aerodynamic simulation software using the mixing planes may be used. On reading the present description the person skilled in the art will be able to make an adaptation to take account of the angular sectors in accordance with the disclosure herein.

In a step 307, the simulation calculation parameters are defined. These are notably simulation conditions: flight altitude, Mach number, engine blade rotation speed or any other parameter usually employed for aerodynamic simulations. Moreover, the software is fed the position of the mixing planes defined in the step 302 and the subdivisions thereof.

Once the simulation has been initialized with the calculation parameters and the mixing planes, the simulation is launched in the step 308.

In the step 309, following the simulation, the aerodynamic forces on the structure of the aircraft (fuselage, wings and engine, excluding the blades) are obtained. These results undergo processing in order to determine the total forces on the structure.

In parallel, in the step 310, following the simulation, the aerodynamic forces on the blades are obtained. These results undergo processing in the step 311 to determine the total forces on the engine as a whole and then on the structure.

Two steps 312, 313 may then be carried out as alternatives or in combination. In the step 312, the overall forces on the engine are obtained by calculating the weighted sum of the forces on each blade. The forces on each blade are weighted by the area of the angular sector with which each blade is associated. Remember that the angular sectors need not be regular. In the step 313, force fluctuations are obtained by comparing the forces obtained for the blades of the engine.

On the basis of the results of the steps 309, 312 and 313, the total forces on the structure of the aircraft (airframe and engine) are obtained by summation of the forces previously calculated.

It is therefore possible to determine, in a step 315, if the shapes defined in the step 300 satisfy a predefined specification. If so (YES), the process terminates in the step 316 and the design of the structure of the aircraft is finished. If not (NO), the shape of the airframe and/or of the engine is modified in a step 317 as a function of the simulation results obtained. The process can then start again from the step 300.

If a modeled structure offers satisfactory simulation results, the method may be followed by a step of manufacture of the structure. An aircraft is therefore obtained satisfying specific criteria of aerodynamic interaction between the airframe and the engines.

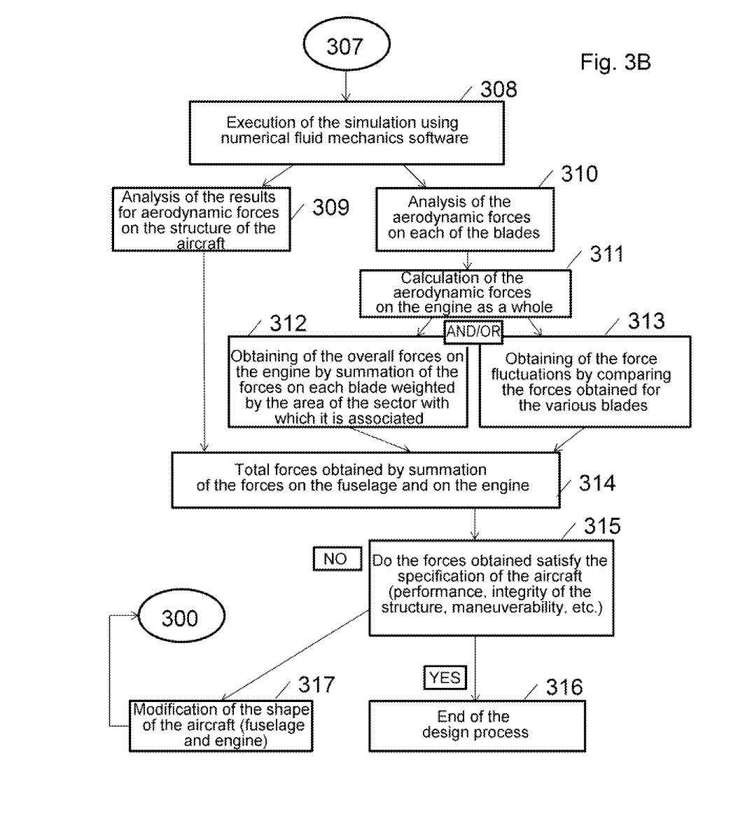

FIG. 4 shows a computer simulation device in accordance with embodiments. The device 40 includes a memory unit (MEM) 41. This memory unit includes a random access memory for temporary storage of calculation data used during the execution of a method in accordance with one embodiment. The memory unit further includes a non-volatile memory (for example of the EEPROM type) for storing, for example, a computer program in accordance with one embodiment for its execution by a processor (not shown) of a processing unit (PROC) 42 of the equipment. The person skilled in the art will be able on reading the flowcharts of FIGS. 3A and 3B and the present detailed description to produce a computer program for implementing a method in accordance with one embodiment of the disclosure herein.

The memory may also store other data referred to above, for example an aircraft mechanical structure model, a meshing of the latter, etc.

The device further includes a communication unit (COM) 43 to provide communications, for example to receive mechanical structure modeling data. The communication unit may also be used to transmit simulation results. In particular, the communication unit may be configured to communicate with a modeling and simulation database, with a user interface, with a communication network, etc.

The present disclosure has been described and shown in the present detailed description with reference to the appended figures. However, the present disclosure is not limited to the embodiments shown. Other variants, embodiments and combinations of features may be deduced and implemented by the person skilled in the art on reading the present description and from the appended figures.

A person skilled in the field of the disclosure herein could apply modifications or adaptations to meet specific requirements.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of simulation by computer of an airframe-engine aerodynamic interaction in an aircraft, comprising:
defining at least one mixing plane at an input and/or output of a modeling of at least one engine of the aircraft,
defining a plurality of angular sectors of the mixing plane centered on a rotation axis of the engine,
executing a mixing plane aerodynamic simulation based on the plurality of angular sectors,
obtaining at least one simulation result in at least one angular sector of the plurality, and
determining aerodynamic interaction between the engine and the airframe of the aircraft at least on a basis of the at least one result.

2. The method according to claim 1, wherein the sectors are regular in at least one part of the mixing plane and wherein simulation calculations are carried out in a sector of the at least one part, the calculation results being extended to the other sectors of the part on the basis of their periodicity.

3. The method according to claim 1, wherein the angular sectors are defined in correspondence with blades of the engine.

4. The method according to claim 3, wherein the simulation is carried out for a position of the blades of the engine, simulation calculation results obtained for the position being extended to the other positions of the blades.

5. The method according to claim 1, wherein the mixing plane is subdivided into a plurality of parts and wherein simulation calculations are carried out for at least one sector of each of the parts, the calculation results for each sector in a part being extended to the other sectors of the part on the basis of their periodicity.

6. The method according to claim 1, wherein the sectors are defined in correspondence with meshing lines of the model.

7. The method according to claim 1, wherein at least one angular sector has an area equal to a multiple of the area of a blade of the engine.

8. The method according to claim 1, wherein at least one angular sector has an area equal to the area of a blade of the engine.

9. A device for simulation by computer of the airframe-engine interaction in an aircraft, including a processing unit configured to implement a method according to claim 1.

10. One or more non-transitory computer readable mediums storing instructions that, when executed by one or more processors, cause the one or more processors to simulate an airframe-engine aerodynamic interaction in an aircraft by performing operations comprising:
defining at least one mixing plane at an input and/or output of a modeling of at least one engine of the aircraft,
defining a plurality of angular sectors of the mixing plane centered on a rotation axis of the engine,
executing a mixing plane aerodynamic simulation based on the plurality of angular sectors,
obtaining at least one simulation result in at least one angular sector of the plurality, and
determining aerodynamic interaction between the engine and the airframe of the aircraft at least on a basis of the at least one result.
